(19) United States
(12) Patent Application Publication
(10) Pub. No.: US 2021/0048819 A1
(43) Pub. Date: Feb. 18, 2021

(54) APPARATUS AND METHOD FOR DETERMINING JUNCTION

(71) Applicant: Electronics and Telecommunications Research Institute, Daejeon (KR)

(72) Inventors: Seung Min CHOI, Daejeon (KR); Seung Hwan PARK, Daejeon (KR); Beom Su SEO, Sejong-si (KR); Seung Ik LEE, Cheongju-si Chungcheongbuk-do (KR); Jae Young LEE, Daejeon (KR); Sung Lok CHOI, Daejeon (KR)

(73) Assignee: Electronics and Telecommunications Research Institute, Daejeon (KR)

(21) Appl. No.: 16/993,047

(22) Filed: Aug. 13, 2020

(30) Foreign Application Priority Data
Aug. 14, 2019 (KR) 10-2019-0099932
Jul. 27, 2020 (KR) 10-2020-0093396

(51) Int. Cl. G05D 1/00; G06K 9/00; G06K 9/32; G05D 1/02; G01C 21/34

(52) U.S. Cl. CPC G05D 1/0088; G06K 9/00798; G01C 21/3407; G05D 1/0231; G06K 9/3275

(57) ABSTRACT

Disclosed are an apparatus and method for determining a junction, and more particularly, a junction determination apparatus and method for robot driving. The junction determination apparatus includes an input unit configured to receive information regarding a topology route from a current location to a destination, a memory configured to store a driving program using the information regarding the topology route, and a processor configured to execute the program. The processor is configured to transmit a driving-related command using the information regarding the topology route and a result of determining the junction.

### CROSS-REFERENCE TO RELATED APPLICATION

This application claims priority to and the benefit of Korean Patent Application No. 10-2019-0099932, filed on Aug. 14, 2019, and Korean Patent Application No. 10-2020-0093396, filed on Jul. 27, 2020, the disclosure of which is incorporated herein by reference in its entirety.

### BACKGROUND

### 1. Field of the Invention

The present invention relates to an apparatus and method for determining a junction, and more particularly, to a junction determination apparatus and method for robot driving.

### 2. Discussion of Related Art

Autonomous robot driving according to the related art utilizes simultaneous localization and mapping (SLAM) technology in which a robot travels based on a pre-built precise map or SLAM technology in which a robot randomly moves in a new environment to build a precise map by itself and then travels based on the precise map.

In the related art, there is a limitation in use in the case of a change in a map, a lack of time to build a precise map, or inaccurate localization.

### SUMMARY OF THE INVENTION

The present invention has been proposed to solve the above-mentioned problems and is directed to providing a junction determination apparatus and method for using road topology information and recognizing a junction (an intersection) to perform driving.

According to an aspect of the present invention, there is a junction determination apparatus including an input unit configured to receive information regarding a topology route from a current location to a destination, a memory configured to store a driving program using the information regarding the topology route, and a processor configured to execute the program. The processor is configured to transmit a driving-related command using the information regarding the topology route and a result of determining the junction.

The information regarding the topology route includes junction information and block information.

The processor determines whether the current location is a junction and determines the next block at the junction according to the topology route.

The processor operates a junction determining logic at an estimated time when a vicinity of the next junction will be reached in consideration of movement information.

The processor defines junction types into a predetermined number of classes.

When a parameter regarding a junction type is included in road view information, the processor acquires a junction image using the parameter.

The processor acquires a junction image using movement direction indication information included in the road view information.

The processor acquires a junction image in consideration of a change in motion vector extracted from a road driving image.

The processor performs rotation and scaling on the acquired junction image.

According to another aspect of the present invention, there is a junction determination method including operations of (a) performing training for junction determination, (b) using a result of the training in operation (a) to determine a junction while driving using information regarding a topology route from a current location to a destination, and (c) determining a movement direction at the junction and transmitting a driving-related command.

Operation (a) includes acquiring a junction image using a parameter related to an intersection type included in road view information, using movement direction indication information included in the road view information, or using a change in motion vector extracted from a road driving image.

Operation (a) includes performing rotation and scaling on the junction image.

Operation (b) includes periodically determining whether a junction is present while driving using the information regarding the topology route, wherein the information includes junction information and block information.

Operation (b) includes operating a junction determining logic at an estimated time when a vicinity of the next junction will be reached in consideration of movement information.

Operation (c) includes the next block using the information regarding the topology information when the current location is a junction.

### BRIEF DESCRIPTION OF THE DRAWINGS

FIG. 1 shows a junction determination apparatus according to an embodiment of the present invention.

FIG. 2 shows an example of finding a route at a topology level according to an embodiment of the present invention.

FIGS. 3A and 3B show the type and class of an intersection.

FIGS. 4A and 4B show the numbers of arrows of a front view and a head-down view.

FIG. 5 shows a junction determination method according to an embodiment of the present invention.

FIG. 6 shows a training and test process for the junction determination method according to an embodiment of the present invention.

### DETAILED DESCRIPTION OF EXEMPLARY EMBODIMENTS

These and other objects, advantages and features of the present invention, and implementation methods thereof will be clarified through following embodiments described with reference to the accompanying drawings.

The present invention may, however, be embodied in different forms and should not be construed as being limited to the embodiments set forth herein. Rather, these embodiments are provided so that this disclosure will fully convey the objects, configurations, and effects of the present invention to those skilled in the art. The scope of the present invention is defined solely by the appended claims.

The terminology used herein is for the purpose of describing particular embodiments only and is not intended to be limiting of the invention. As used herein, the singular forms “a,” “an,” and “one” include the plural unless the context clearly indicates otherwise. The terms “comprises” and/or “comprising,” when used in this specification, specify the presence of stated elements, steps, operations, and/or components, but do not preclude the presence or addition of one or more other elements, steps, operations, and/or components.

Hereinafter, in order to help those skilled in the art to understand the present invention, the background of the present invention will be described first, and then the embodiments of the present invention will be described in detail.

Autonomous robot driving according to the related art is difficult to use when a change that is not just an obstacle occurs at a specific point on a map or when there is insufficient time to build a precise map.

Also, even in a situation where a precision map is provided, there is a limitation in use when the current localization is incorrect.

There is also a limitation in use when only low-resolution map information with a non-precise topology level is provided.

The present invention has been proposed to solve the above-mentioned problems and is directed to providing a junction determination apparatus and method for perform driving using only road topology information.

According to an embodiment of the present invention, it is possible to plan a route at the topology level and reach a node immediately preceding a destination node using only a topology scenario through the recognition of a junction (intersection).

According to an embodiment of the present invention, the apparatus and method include building training data for junction recognition and performing deep learning and application for junction recognition.

According to an embodiment of the present invention, the apparatus and method include traveling to the vicinity of a final destination through the recognition of junctions using road topology and the current initial location information without a precise map.

The apparatus and method include splitting the movement section into blocks, going straight before a block including the next intersection, and then moving according to the shape of the road to the next intersection.

The apparatus and method include detecting an intersection at certain intervals and determining whether the next block has been reached.

When it is determined that the next block has been reached, the apparatus and method include determining the following block after the next block on the basis of the route on the topology, turning to or going straight in a corresponding direction, splitting the movement section into blocks as described above, and then going straight before a block including the next intersection.

According to an embodiment of the present invention, the apparatus and method include defining the type of a junction as straight, 3-way, 4-way, or S-way and classifying the junction as a separate class depending on an entry direction in the case of 3-way and 5-way.

According to an embodiment of the present invention, an augmentation process is performed through rotation and scaling based on a collected image to improve the representativeness of the image.

In this case, when rotation-related augmentation is performed, a rotation angle is subdivided because various scenes can be observed according to an angle at which a moving object enters an intersection.

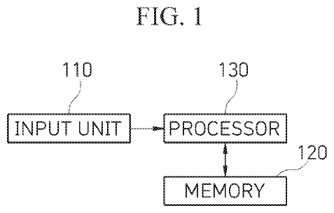

FIG. 1 shows a junction determination apparatus according to an embodiment of the present invention.

The junction determination apparatus according to the present invention includes an input unit 110 configured to receive information regarding a topology route from a current location to a destination, a memory 120 configured to store a driving program using the information regarding the topology route, and a processor 130 configured to execute the program. The processor 130 is configured to transmit a driving-related command using the information regarding the topology route and a result of determining a junction.

The information regarding the topology route includes junction information and block information.

The processor 130 determines whether the current location is a junction and determines the next block at the junction according to the topology route.

The processor 130 defines junction types as a predetermined number of classes.

When a parameter regarding a junction type is included in road view information, the processor acquires a junction image using the parameter.

The processor 130 acquires a junction image using movement direction indication information included in the road view information.

The processor 130 acquires a junction image in consideration of a change in motion vector extracted from a road driving image.

The processor 130 performs rotation and scaling on the acquired junction image.

The processor operates a junction determining logic at an estimated time when the vicinity of the next junction will be reached in consideration of movement information.

The movement information includes the movement distance, movement speed, movement trajectory, and the like of a robot after passing through the current junction.

When detecting the junction, the processor 130 considers information regarding a distance between junctions and information regarding a distance traveled by a moving object (location information of a moving object).

For example, it is assumed that the processor 130 may be set to start to detect a junction when the remaining distance is 100 meters and that the distance from the current junction to the next junction is 500 meters. In this case, the processor 130 starts to detect a junction when a moving object travels 400 meters from the current junction.

The processor 130 periodically checks for a junction and operates a junction determining logic at an estimated time when the vicinity of the junction will be reached in consideration of a distance from the next junction on the topology map and the current movement speed of the robot.

In detail, the measurement time for determining the next junction is defined as “(distance to the next junction)/(average speed of robot)−t₀,” where t₀ is a stand-by time determined by an experiment.

When detecting the junction, the processor 130 uses distance information between junctions and traveled distance information and traveled trajectory information of the moving object.

The processor 130 calculates the remaining distance to a predetermined point where the processor 130 starts to detect a junction using the traveled distance information and the traveled trajectory information of the moving object. When the moving object reaches the junction detection starting point, the processor 130 performs junction detection.

Thus, it is possible to minimize the battery consumption of a mobile robot.

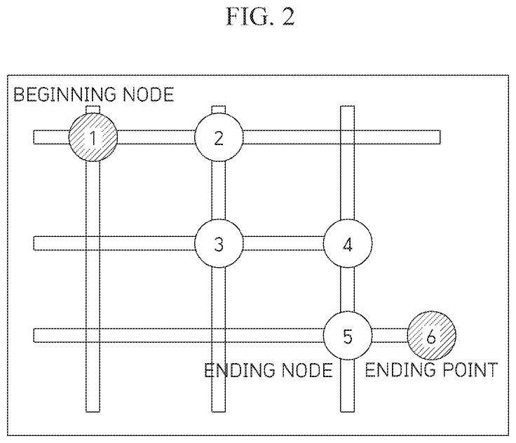

FIG. 2 shows an example of finding a route at a topology level according to an embodiment of the present invention.

The input unit 110 receives route information from the current location to a desired destination from a navigation service provider (Google, Naver, Daum, etc.) or a self-developed navigation service.

In this case, the route information is provided at the level of a junction (intersection) and a block. Referring to FIG. 2, a route of \hat{2} going straight for one block from the current location (\hat{1}), \hat{3} turning right and going straight for one block, \hat{4} turning left and moving one block, \hat{5} turning right and moving one block, and then \hat{6} turning left for the last time and going straight until meeting an ending point, which is the vicinity of a destination, is formed.

The processor 130 uses a topology route acquired through the input unit 110, distinguishes between a junction and a general straight road, and transmits a driving-related command signal such that the apparatus moves from an origin to a destination while finding a junction.

The processor 130 secures driving stability by determining the type of the junction using an acquired image and periodically checking whether the junction matches the topology route.

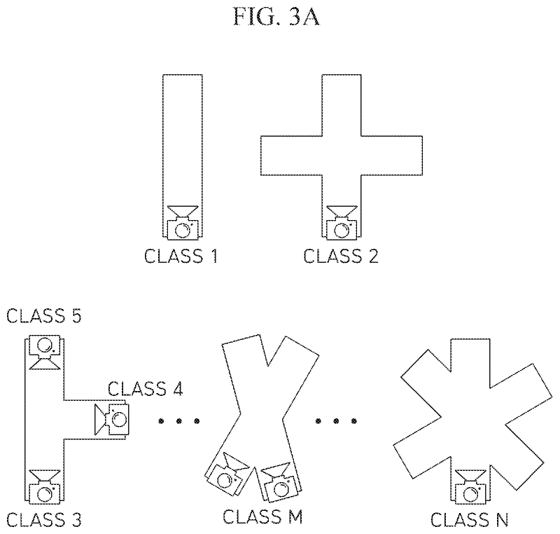

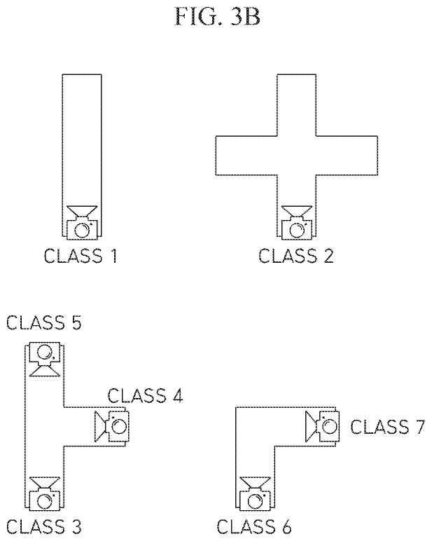

FIGS. 3A and 3B show the type and class of an intersection.

FIG. 3A shows the types of junctions, and FIG. 3B shows that junctions are defined as seven classes in order to improve classification performance and ease of data acquisition.

In order to shorten a development time including a data acquisition process and a training process and improve performance, the junctions may be classified into less than seven classes.

According to an embodiment of the present invention the types of the junctions may be defined as seven classes in consideration of movement direction information at the junction.

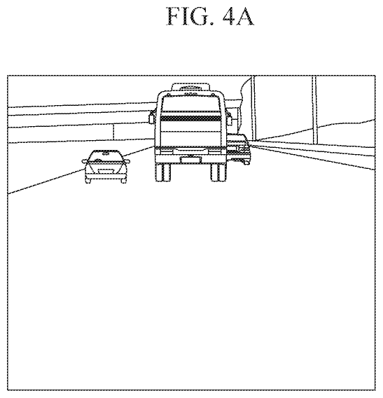

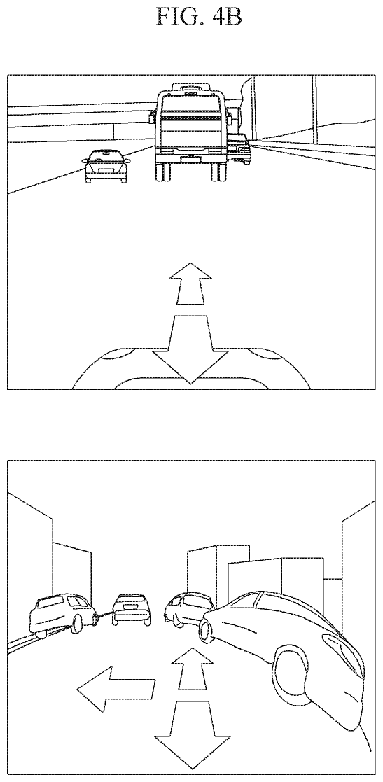

FIGS. 4A and 4B show the numbers of arrows of a front view and a head-down view.

In order to recognize and classify junctions, neural network training requires a great deal of resources in a data collection process.

This is because training with an amount of data smaller than an amount of internal network parameters (weight) to be trained in a general case causes overfitting or low classification accuracy.

Accordingly, as much training data as possible is required, but an image of a junction (intersection) is acquired more intensively than an image of a straight road.

When a parameter indicating an intersection type is provided while a road view is utilized, the intersection type is used as a truth value (ground truth) for the current view image.

In this case, the parameter indicating the intersection type includes information regarding latitude, longitude, a view angle, and whether the current view image is an intersection.

When the parameter indicating the intersection type is not provided, but the movement direction (e.g., arrow) of the road view is overlaid on the view image while a road view is utilized, the number and directions of direction indications are determined and used as truth values.

For example, when a head-down view is set, an arrow icon indicating the movement direction in the road view is created as shown in FIG. 4B. In the case of a straight route, a total of two arrow icons, i.e., one icon ahead and the other icon behind are displayed. In the case of a three-way, three arrow icons are displayed. In the case of a four-way, four arrow icons are displayed.

The number of arrows is detected using a feature detection technique such as SURF and is used as a truth value for the class of the intersection in the front view image as shown in FIG. 4A.

The map service of a navigation service provider includes similar display functions. When it is difficult to acquire metadata for intersection information, a display icon is utilized in an above-described manner.

When the parameter indicating the intersection type is not provided and also the movement direction information is not overlaid on the view image while the road view is utilized, a truth value is generated through an administrator's check or image processing.

In obtaining an intersection image according to an embodiment of the present invention, a road driving image may be utilized.

In the case of a video, many frames may be acquired, and a video regarding the normal driving of a vehicle or robot is secured.

A motion vector of a main driving direction is extracted from the video, and when this value changes and approaches zero, it is determined that a captured frame corresponds to an intersection image.

When a data collection process is completed, it is necessary to train a junction classifier network.

According to an embodiment of the present invention, a junction classifier is trained using a neural network or a network (vggnet, AlexNet, LeNet) configured to improve performance or reduce the amount of computation.

A selected network is trained using a truth value and an image of a 4-way intersection, a 3-way intersection, a straight road, or the like.

Since an actual image captured by a robot may not match the direction of the intersection, it is possible to improve the representativeness of the image by performing an augmentation process through the rotation and scaling of a collected image according to an embodiment of the present invention.

In this case, images are collected in various situations such that the robot is robust against vehicles parked on roads, pedestrians, day and night brightness, and seasonal weather changes.

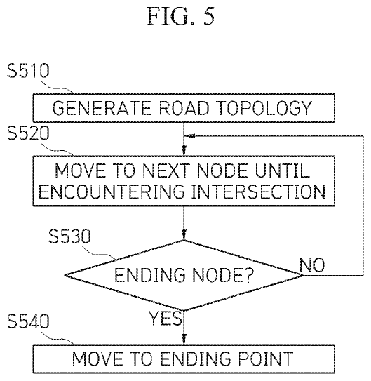

FIG. 5 shows a junction determination method according to an embodiment of the present invention.

Operation S510, which is a road topology generation operation, includes receiving route information from the current location to a desired destination. In this case, the route information includes junction information and block information.

Operation S520 includes periodically detecting an intersection and moving to the next node until encountering the intersection.

Operation S520 includes splitting a movement section into blocks and traveling according to a road shape before a block including the next intersection.

Operation S530 includes determining whether the currently reached node is an ending node.

When the determination result in operation S530 is that the current node is not the ending node, the process returns to operation S520. When the determination result in operation S530 is that the current node is the ending node, the method includes moving to an ending point (S540).

Operation S520 of FIG. 5, which is an operation of traveling until a junction of the next destination is detected, includes entering a junction when the junction is detected and continuing to travel to the next node through a process of calculating the next junction.

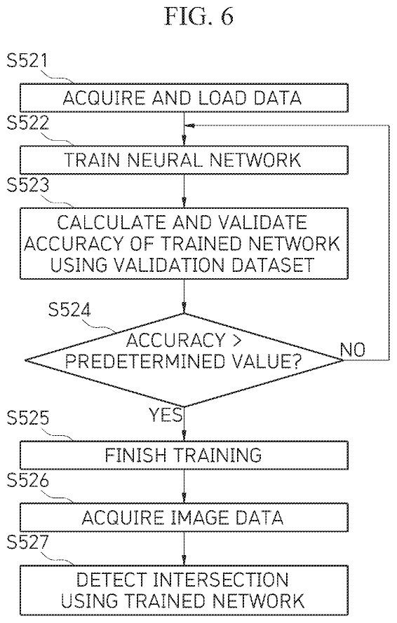

FIG. 6 shows a training and test process for the junction determination method according to an embodiment of the present invention.

Operation S521 includes acquiring data and loading training dataset.

When the training starts, operation S522 includes training a neural network using the acquired data.

Operation S523 includes calculating and validating the accuracy of a trained network using a validation dataset.

Operation S524 includes determining whether the calculated accuracy is greater than a predetermined value and returning to operation S522 when the accuracy is less than or equal to the predetermined value in S524.

When it is determined in operation S524 that the accuracy is greater than the predetermined value, the training is finished (S525).

When a test is started, operation S526 includes acquiring image data.

Operation S527 includes detecting an intersection using the neural network trained in operation S522.

When it is determined that no intersection is detected, operation S527 includes continuing to travel.

When it is determined that an intersection is detected, operation S527 includes entering the corresponding intersection, setting a driving direction according to topology, and continuing to travel toward the calculated next junction.

According to the present invention, it is possible to allow autonomous driving in an environment in which a precise map is difficult to generate (e.g., an environment in which vehicles cannot pass, such as an alleyway or an old town) or an environment in which self-localization is difficult (e.g., a metropolitan environment in which GPS signals are incorrect). Also, the present invention is applicable to robots that travel on sidewalks (footways for pedestrians) rather than roadways.

Advantageous effects of the present invention are not limited to the aforementioned effects, and other effects not described herein will be clearly understood by those skilled in the art from the above description.

Meanwhile, the junction determination method according to an embodiment of the present invention may be implemented in a computer system or recorded on a recording medium. The computer system may include at least one processor, memory, user input device, data communication bus, user output device, and storage. The above-described elements perform data communication through the data communication bus.

The computer system may further include a network interface coupled to a network. The processor may be a central processing unit (CPU) or a semiconductor device for processing instructions stored in a memory and/or a storage.

The memory and storage may include various types of volatile or non-volatile storage media. For example, the memory may include a read-only memory (ROM) and a random access memory (RAM).

Accordingly, the junction determination method according to an embodiment of the present invention may be implemented as a computer-executable method. When the junction determination method according to an embodiment of the present invention is performed by a computer device, computer-readable instructions may implement the junction determination method according to an embodiment of the present invention.

Meanwhile, the junction determination method according to the present invention may be embodied as computer-readable codes on a computer-readable recording medium. The computer-readable recording medium includes any type of recording medium in which data that can be decrypted by a computer system is stored. For example, the computer-readable recording medium may include a ROM, a RAM, a magnetic tape, a magnetic disk, a flash memory, an optical data storage device, and the like. Further, the computer-readable recording media can be stored and carried out as codes that are distributed in a computer system connected to a computer network and that are readable in a distributed manner.

What is claimed is:

1. A junction determination apparatus comprising:
an input unit configured to receive information regarding a topology route from a current location to a destination;
a memory configured to store a driving program using the information regarding the topology route; and
a processor configured to execute the program,
wherein the processor is configured to transmit a driving-related command using the information regarding the topology route and a result of determining a junction.

2. The junction determination apparatus of claim 1, wherein the information regarding the topology route comprises junction information and block information.

3. The junction determination apparatus of claim 1, wherein the processor determines whether the current location is a junction and determines the next block at the junction according to the topology route.

4. The junction determination apparatus of claim 3, wherein the processor operates a junction determining logic at an estimated time when a vicinity of the next junction will be reached in consideration of movement information.

5. The junction determination apparatus of claim 1, wherein the processor defines junction types into a predetermined number of classes.

6. The junction determination apparatus of claim 1, wherein when a parameter indicating a junction type is included in road view information, the processor acquires a junction image using the parameter.

7. The junction determination apparatus of claim 1, wherein the processor acquires a junction image using movement direction indication information included in road view information.

8. The junction determination apparatus of claim 1, wherein the processor acquires a junction image in consideration of a change in motion vector extracted from a road driving image.

9. The junction determination apparatus of claim 1, wherein the processor performs rotation and scaling on an acquired junction image.

10. A junction determination method comprising operations of:
(a) performing training for junction determination;
(b) using a result of the training in operation (a) to determine a junction while driving using information regarding a topology route from a current location to a destination; and
(c) determining a movement direction at the junction and transmitting a driving-related command.

11. The junction determination method of claim 10, wherein operation (a) comprises acquiring a junction image using a parameter related to an intersection type included in road view information, using movement direction indication information included in the road view information, or using a change in motion vector extracted from a road driving image.

12. The junction determination method of claim 11, wherein operation (a) comprises performing rotation and scaling on the junction image.

13. The junction determination method of claim 10, wherein operation (b) comprises periodically determining whether a junction is present while driving using the information regarding the topology route, wherein the information includes junction information and block information.

14. The junction determination method of claim 13, wherein operation (b) comprises operating a junction determining logic at an estimated time when a vicinity of the next junction will be reached in consideration of movement information.

15. The junction determination method of claim 10, wherein operation (c) comprises determining the next block using the topology route information when the current location is the junction.
